(19) United States
(12) Patent Application Publication
(10) Pub. No.: US 2026/0235479 A1
(43) Pub. Date: Aug. 13, 2026

(54) TUBE FOR VOLATILE AND SEMI-VOLATILE COMPOUND SAMPLING AND SAMPLING PROCESS

(71) Applicant: VSOL ANÁLISES AMBIENTAIS LTDA, SÃO PAULO (BR)

(72) Inventor: Rafael Fernando SATO SATO, SÃO PAULO (BR)

(21) Appl. No.: 19/159,633

(22) PCT Filed: Jun. 26, 2024
(86) PCT No.: PCT/BR2024/050275

§ 371 Date: Aug. 26, 2025

(30) Foreign Application Priority Data
Sep. 4, 2023 (BR) 1020230178570

(51) Int. Cl. G01N 1/22; G01N 1/24

(52) U.S. Cl. CPC G01N 1/2214; G01N 1/2294; G01N 1/24; G01N 2001/247

(57) ABSTRACT

Sampling system equipped with a tube with a hydrophobic adsorbent element of hybrid category for passive or active sampling of volatile and semi-volatile compounds for investigations of environmental contamination or for prospecting sources of natural resources such as oil in its various forms and its sampling process.

This invention is located in the field of environmental chemistry, specifically instruments for sampling and analyzing air in adsorbent materials to determine the chemical composition of collected samples, specifically a tube with a hydrophobic adsorbent element in a hybrid active and passive category for sampling volatile and semi-volatile compounds in environmental contamination investigations or for prospecting natural resource sources such as oil in its various forms and sampling processes.

The management of contaminated areas is a sector that is more than 30 years old and during its evolution several tools were created to assist in the investigations necessary for management. Despite this, there is still a great shortage of economically viable and technically appropriate tools for environmental contamination assessments in contaminant scan mode. Tools for environmental investigation in scan mode require versatility of application and list of compounds, performance in different environmental conditions, such as very humid environments or even the presence of water that can affect the collection process and a reduced cost when compared to other techniques.

An in-depth analysis of the existing technology by this inventor reveals a lack of volatile and semi-volatile compound samplers for hybrid active or passive sampling with quantitative analysis and solvent sample extraction, such as the Waterloo Membrane Sampler (WMS), which is a sampling device, a glassy container containing an adsorbent element with a lid and a vapor/gas permeable membrane, for quantitative assessment of volatile organic compounds by passive sampling only. The analysis is performed by a solvent sample preparation or by thermal desorption, processes which are followed by a gas chromatography analysis.

Also, the US EPA TO-17 methodology discloses an analytical and sampling method disclosed by the US EPA for volatile organic compound analyses for quantitative evaluation by active-only sampling. Sampling is performed in tubes containing one or more adsorbent elements. The extraction is performed only by the thermal desorption methodology of the tube and then by gas chromatography analysis.

Furthermore, the USEPA TO-3C methodology is an analytical and sampling method disclosed by the US EPA for analysis of semi-volatile organic compounds for quantitative evaluation by active-only sampling. Sampling is performed in tubes containing adsorbent elements and also with a polyurethane filter. Preparation is done by extraction using solvents and the Soxhlet process. The analysis is performed by gas chromatography.

Finally, the NIOSH methodology is an analytical method for occupational and sampling assessments described by NIOSH for analyses of a limited list of volatile organic compounds. Sampling is active and glass tubes containing coconut activated carbon are used. There is a major limitation in this case as coconut activated carbon is not hydrophobic and can be interfered with by moisture when applied to soil air sampling, typically with high moisture contents.

In view of the gaps in the technique, the proposed invention is a sampling system equipped with a tube (1) with a mixture of passive or active hybrid category adsorbent materials for sampling volatile and semi-volatile compounds for investigations of environmental contamination or for prospecting natural resource sources such as oil in its various forms and its sampling process.

The invention is a tube (1) composed of metallic, glassy or polymeric material, rigid and inert to the substances or compounds to be sampled and analyzed. The outer surface of the pipe has engravings of an arrow (3) indicating the sampling flow and the pipe serial number (4) for traceability.

The pipe has two polyethylene caps (5) for closure.

Internally it is composed of a mixture of hydrophobic activated carbon spheres (2) of different sizes, from 0.4 to 0.8 mm and surface area from 1000 to 1300 m²/g that are fixed with the use of metallic or vitreous fabrics or other inert materials (6) to the substances or compounds that will be sampled and analyzed. The set also has two stainless steel retainer springs (7) that prevent the movement of the internal elements inside the tube during active sampling.

The invention may be better understood with the aid of the figures.

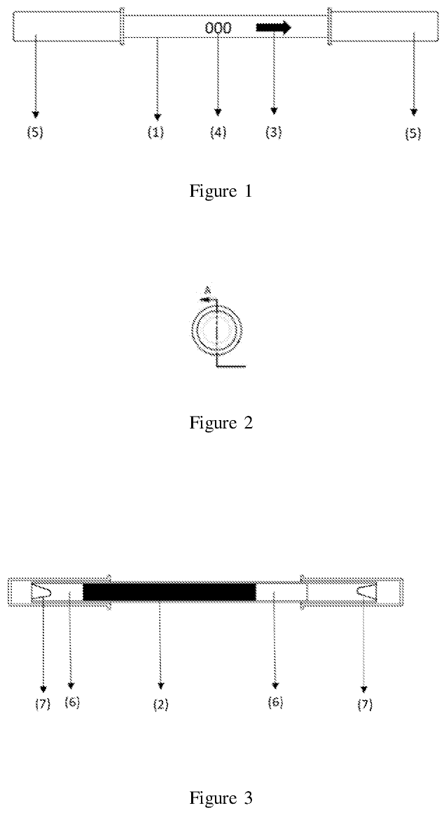

FIG. 1 shows a front view of the sampler tube (1)

FIG. 2 reveals a side view of the sampler tube (1) without a cap

FIG. 3 shows the internal composition of the tube (1).

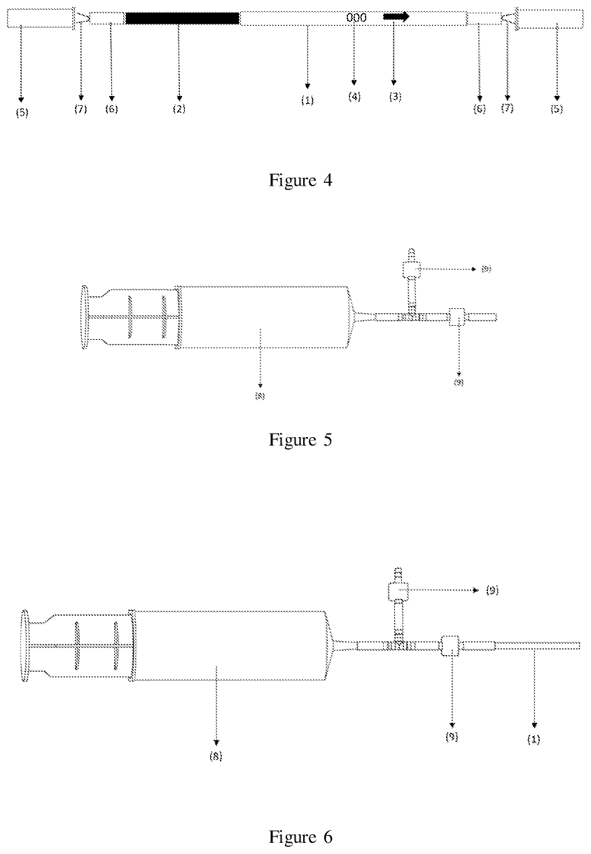

FIG. 4 shows an expanded view of the tube (1) and internal composition For active sampling, in addition to the sampler tube (1), a syringe (8) coupled to a check valve system (9) is used.

FIG. 5 shows the syringe (8) and the check valve system (9).

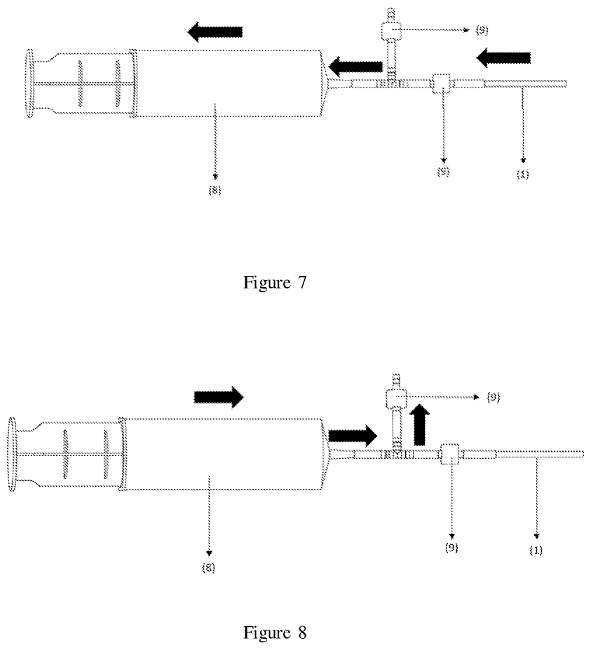

For active sampling, the sampling tube (1), the syringe (8) and the check valve system (9) are used. The system facilitates the sampling process by avoiding errors during the process, as there is no need to disconnect the sampler tube from the system.
i. Remove the cap of the sampler tube part (1) to where the arrow (3) points;
ii. Connect the sampler tube (1) to the syringe (8) as shown in FIG. 6.
iii. Remove the cap (5) still remaining from the sampler tube (1) and connect to the sampling point;
iv. Pull and push the syringe plunger according to the required volume to be sampled. The check valve system only allows airflow in the flows indicated by FIG. 7, pulling the plunger, and 8, pushing the plunger;
v. Disconnect sampler tube (1);
vi. Replace the caps (5).

FIG. 6 shows the tube (1) connected to the syringe (8) and valve system (9).

FIG. 7 shows the flow by pulling the syringe plunger when air from the sampled point passes through the sampler.

FIG. 8 shows the flow pushing the syringe plunger when air is relieved by the side check valve.

For passive sampling only a specific sampling cap (10) is used. It is a cap that has a silicone tube section (11) and a rigid metallic or polymeric support (12) and a hydrophobic and olephobic membrane (13), composed of polytetrafluoroethylene (PTFE) or acrylic copolymers, which allows the free passage of the compounds and/or substances of interest and which prevents the formation of barriers by the presence of water in its liquid state in the catchment region of the compounds and/or substances of interest. In addition, membranes drastically reduce the passage of water in vapor form, which can cause analytical problems such as low sensitivity.

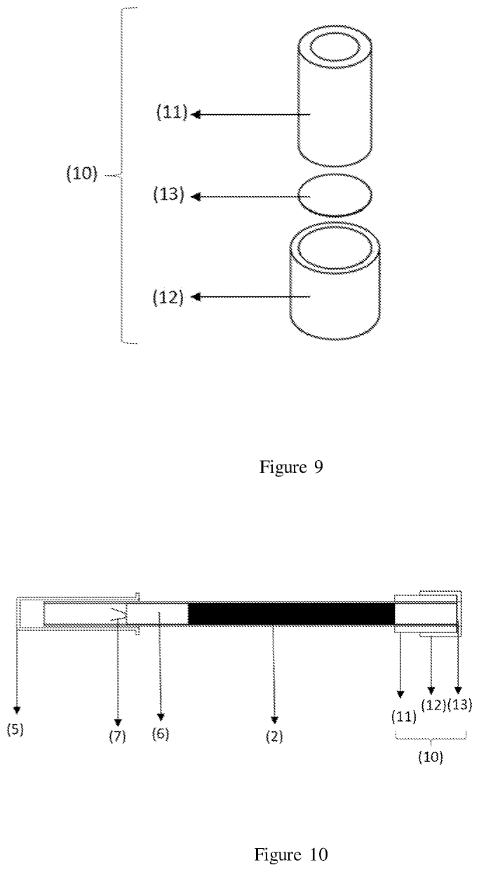

FIG. 9 illustrates the sampling cap set (10) used for the passive sampling process.

For passive sampling, the sampler tube (1) and the sampling cap (10) are used.
A. Remove the cap from the counter sampler tube part (1) to where the flow arrow (3) points;
B. Connect the sampler tube (1) to the sampling cap set (10).
C. Position the sampler at the location to be sampled. For example: Positioned within a building for indoor air assessment or ground burial for soil air assessment.
D. After the sampling period, normally 7-14 days, remove sampler
E. Replace cap (5)

FIG. 10 shows the internal composition of the pipe assembled for passive sampling.

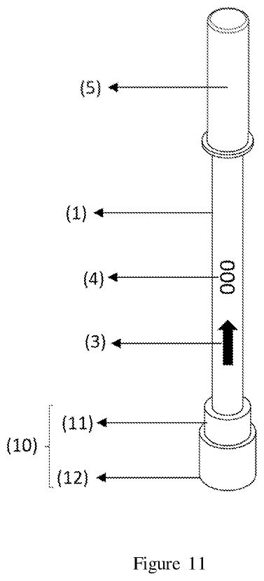

FIG. 11 demonstrates a front view of the sampler tube mounted for passive sampling.

In summary, the new system combined with the process is the only sampler designed for active or passive sampling. For this type of sampler it is possible to analyze volatile compounds both by solvent extraction. Furthermore, the extraction can be performed using different solvents and, therefore, allows the inclusion of analysis of semi-volatile compounds as well as multiple analyses including dilutions that are not suitable for the thermal desorption method and the adsorbent elements composed of a mixture of hydrophobic activated carbon spheres (2) of different sizes, from 0.4 to 0.8 mm and surface area from 1000 to 1300 m²/g and selected for the sampling of various organic compounds. The hydrophobicity of the adsorbent elements inhibits the interference of moisture by saturation and therefore does not generate false negatives.

This invention is not limited to the representations commented or illustrated herein, and should be understood in its broad scope. Many modifications and other representations of the invention will come to the mind of one skilled in the art to which this invention belongs, having the benefit of the teaching presented in the previous descriptions and attached drawings. Furthermore, it is to be understood that the invention is not limited to the specific form disclosed, and that modifications and other forms are understood to be included within the scope of the appended claims.

Although specific terms are employed herein, they are used only in a generic and descriptive manner and not for the purpose of limitation.

1. SAMPLING TUBE characterized by its components: tube (1) of metallic, glassy or polymeric material, rigid and inert, in which its external surface has engravings of an arrow (3) and tube serial number (4); two caps, preferably in polyethylene (5), with a hydrophobic and olephobic membrane (13), composed of polytetrafluoroethylene (PTFE) or acrylic copolymers; internally it is composed of a mixture of hydrophobic activated carbon spheres (2) of different sizes, from 0.4 to 0.8 mm and surface area from 1000 to 1300 m²/g, fixed in metallic and vitreous fabrics (6); two retainer springs (7).

2. PROCESS characterized by its steps:
i. Remove the cap of the sampler tube part (1) to where the arrow (3) points;
ii. Connect the sampler tube (1) to the syringe (8);
iii. Remove the cap (5) still remaining from the sampler tube (1) and connect to the sampling point;
iv. Pull and push the syringe plunger according to the volume to be sampled;
v. Disconnect the sampler tube (1);
vi. Replace the caps (5).

3. PROCESS characterized by its steps:
A. Remove the cap from the counter sampler tube part (1) to where the flow arrow (3) points;
B. Connect the sampler tube (1) to the sampling cap set (10).
C. Position the sampler at the location to be sampled.
D. After the sampling period, remove the sampler;
E. Replace cap (5)
